(19) United States
(12) Patent Application Publication
(10) Pub. No.: US 2024/0363957 A1
(43) Pub. Date: Oct. 31, 2024

(54) PROTECTION DEVICE FOR BATTERY

(71) Applicant: A. Kayser Automotive Systems GmbH, Einbeck (DE)

(72) Inventor: Heiko Freter, Einbeck (DE)

(21) Appl. No.: 18/644,906

(22) Filed: Apr. 24, 2024

(30) Foreign Application Priority Data
Apr. 28, 2023 (DE) 10 2023 111 067.5

(51) Int. Cl. H01M 50/333

(52) U.S. Cl. CPC H01M 50/333; H01M 2220/20

(57) ABSTRACT

A protection device for discharging pressure from a housing has a closure that seals an opening of the housing in a first operating state. A bearing guides the closure to a second operating state without destruction. A clamp is coupled to the closure in the first operating state and positions the closure on the housing. The closure releases the opening of the housing in the second operating state so that the clamp is decoupled from the closure member. In the first operating state, a spring leg of the clamp abuts a first abutment surface of the closure, and the first abutment surface is configured, upon displacement of the closure in the displacement direction to the second operating state, to displace the spring leg such that the spring leg contacts a guide of the bearing and is displaced by the guide such that the spring leg is decoupled from the closure.

### FIELD OF THE INVENTION

The invention relates to a protection device for a housing, a housing comprising such a protection device, a battery system comprising such a housing having the protection device, and a vehicle having such a battery system.

### BACKGROUND OF THE INVENTION

Batteries and other components often are accommodated in a protective housing or container that may be closed substantially hermetically to provide protection from external environmental influences. A protective atmosphere constituted by a certain gas may prevail in the interior of the housing or container.

However, pressure in such a gas-filled housing that is sealed off from the environment may change due to temperature fluctuations, changes in the ambient pressure or a defect of the battery, in particular a short circuit.

A change of the relative pressure produces a mechanical load on the housing that may lead to burst and/or collapse.

Membranes have been employed for years in walls of housings to compensate for this relative pressure. These membranes allow for air passage into and/or out of the housing while protecting the interior of the housing from entry of water and dirt.

However, such membranes usually have a limited flow rate. A relative pressure build-up, for example due to heating and/or thermal decomposition of the housing content, may exceed the allowed flow rate of the membrane. In this situation, the membrane can no longer protect the container from inadmissible load, and a further rise in the relative pressure occurs.

Therefore, it is appropriate to provide a protection device that opens a flow cross-section from the housing interior to the environment/atmosphere at an inadmissibly high internal pressure so that a reduction of the relative pressure can be effected in the case of a very rapid build-up of the relative pressure in the interior of the housing.

Prior art protection devices include rupture disks that burst when a specified relative pressure is exceeded and that release a flow cross-section so that the relative pressure can be reduced. However, the opening pressure of the individual rupture disks cannot be controlled before bursting. Thus, very high expenses are necessary in the manufacture of rupture disks to ensure that they burst at a predetermined pressure. A further disadvantage is that such rupture disks are destroyed once they have been triggered. As a result, a new rupture disk must be installed with seals at great expense if the system is to be reused. An additional disadvantage is that rupture disks can only be adapted to changed triggering pressures through extensive testing.

It is advantageous to develop a protection device which can be tested with regard to its real opening pressure at the end of manufacture and only then is attached to a housing. The test can, for example, be carried out as a 100% test at the end of the production process at the manufacturer of the protection device.

For reasons of installation space, weight and/or manufacturing costs, it is particularly advantageous to combine a membrane and a protection device in one structural unit.

Therefore, it is an object of the invention to provide a protection device that protects the interior of a housing and can reliably and rapidly decrease a relative pressure in the interior of the housing. In particular, it is an object of the invention to provide a housing having such a protection device, a battery system having such a housing with the protection device, and a vehicle having such a battery system.

### SUMMARY OF THE INVENTION

A first aspect of the invention relates to a protection device for a housing, in particular for a battery housing. The protection device is configured for discharging a positive pressure from the interior of the housing. More particularly, the housing has an opening, and the protection device has a closure member that is arranged displaceably with respect to the housing between a first operating state and a second operating state. The closure member is configured for sealing the opening of the housing when the closure member is in the first operating state. However, the closure member is configured to be displaced in a displacement direction to the second operating state without destruction. The opening is open when the closure member that is in the second operating state. The protection device further has a bearing member for guiding the closure member and at least one clamping member having at least one spring leg. The at least one clamping member is coupled to the closure member in the first operating state to position the closure member on the housing. However, the closure member releases the opening of the housing in the second operating state, and the at least one clamping member is decoupled from the closure member in the second operating state so that the at least one clamping member exerts substantially no force on the closure member in the second operating state. In the first operating state, the at least one spring leg of the clamping member, in particular a first portion of the spring leg, abuts against a first abutment surface of the closure member. The first abutment surface is configured so that, upon displacement of the closure member in the displacement direction to the second operating state, to displace and/or deform at least part of the spring leg such that the spring leg, in particular a second portion of the spring leg, contacts a guide portion of the bearing member and is displaced and/or deformed by the guide portion such that the spring leg, in particular the first portion of the spring leg, is decoupled from the closure member.

The described protection device advantageously can be displaced and/or brought to the first operating state easily without tools and/or without replacing components after being triggered. Thus, repeated triggering of the protection device is possible. In addition, by the selection and/or design of the clamping member, the triggering pressure can be set in an easy and reliable manner.

The closure member of some embodiments is configured to close and/or cover the opening in the housing substantially tightly. The closure member may be substantially cylindrical, the longitudinal axis of the closure member may substantially correspond to the displacement direction. The bearing member may be integral with the housing and/or be attachable to the housing. Furthermore, the bearing member may cover part of the opening of the housing.

The closure member and/or the protection device may be in the first operating state when and/or as long as a relative pressure in the interior of the housing with respect to the environment does not exceed a first limit value.

The closure member and/or the protection device may be in the second operating state when and/or after a relative pressure in the interior of the housing has exceeded a first limit value.

The at least one spring leg may be decoupled from the closure member in the second operating state so that the at least one spring leg does not exert force on the closure member in the second operating state. In the second operating state, there is no coupling between the clamping member, in particular the at least one spring leg, and the closure member, or at least no coupling that hampers and/or prevents displacement of the closure member away from the housing and/or from the opening.

The closure member of some embodiments is configured and arranged to be displaced by a positive pressure in the interior of the housing. In particular, the protection device is configured such that a force that is directed away from the interior of the housing acts and/or is exerted on the closure member by a positive pressure in the interior of the housing.

The clamping member of some embodiments is coupled to the closure member in the first operating state so as to position and/or fasten and/or hold in position the closure member substantially on the housing and/or the bearing member in the first operating state.

Some embodiments have the first portion of the spring leg and the second portion of the spring leg positioned at different locations in the extension direction of the spring leg. The second portion is preferably arranged distally relative to the first portion, in particular at a distal end region, of the spring leg. Alternatively, the second portion of the spring leg may be arranged medially relative to the first portion of the spring leg and/or between the first portion and a medial end portion of the spring leg.

In particular, the clamping member may be dimensioned and/or designed and/or positioned such that triggering of the protection device, i.e. reaching the second operating state, is set at a desired triggering pressure and/or a predetermined relative pressure in the interior of the housing.

Preferably, at least part of the clamping member is coupled to the housing and/or the bearing member so that the clamping member exerts a force on the closure member. This achieves that the clamping member substantially prevents, or at least significantly reduces, displacement of the closure member in the first operating state with respect to the housing and/or the opening, in particular when a pressure in the interior of the housing does not exceed a first prescribed and/or prescribable limit value. The at least one clamping member may consequently in particular be configured to exert a force on the closure member and to lock and/or hold in position the closure member substantially in the first operating state and/or to substantially prevent, or at least hamper, displacement of the closure member from the first operating state.

In particular, the clamping member may be designed and coupled to the closure member such that, due to a pressure difference between the interior of the housing and the environment, for example, the closure member is displaced with respect to the bearing member and/or the housing and/or the opening and thereby at least part of the clamping member, in particular a first portion of the spring leg, is displaced and/or at least temporarily deformed.

In particular, the protection device is designed such that at least part of the closure member is displaced such that the clamping member is decoupled from the closure member and the closure member releases the opening of the housing at a relative pressure in the interior of the housing of about 0.15 to about 0.8 bars. More preferably, the protection device is designed such that displacement of the closure member from the first operating state to the second operating state is effected at a relative pressure in the interior of the housing of between about 0.3 and about 0.5 bars, and/or that the clamping member allows displacement of the closure member in the displacement direction until the second operating state is reached at a relative pressure of between about 0.3 and about 0.5 bars.

Preferably, the guide portion is configured to displace and/or deform the spring leg substantially in a direction orthogonal to the displacement direction when the spring leg is displaced and/or deformed by the first abutment surface in the displacement direction and comes into contact with the guide portion upon displacement of the closure member. Thereby, in particular, the reliability of reaching the second operating state can be increased since the spring leg is displaced away and/or decoupled from the closure member, in particular the first abutment surface, actively and/or in a guided manner such that displacement of the closure member in the displacement direction is substantially no longer prevented and/or hampered. In other words, the first abutment surface displaces or deforms the spring leg substantially in the displacement direction during the displacement of the closure member in the displacement direction until the spring leg comes into contact with the guide portion and is then additionally displaced and/or deformed in a direction orthogonal to the displacement direction by the guide portion, whereby the spring leg slips from the first abutment surface and the closure member is brought to the second operating state. By virtue of the guide portion, it can be advantageously secured that the spring leg is sufficiently displaced and/or deformed to slip from the first abutment surface even when the spring leg has a component defect, for example an unintended deflection and/or bias. On the other hand, it is not absolutely necessary that the spring leg contacts the guide portion upon displacement of the closure member since a slippage of the spring leg from the first abutment surface may also be ensured by, for example, inclination of the first abutment surface and/or bias of the spring leg in combination with a second abutment surface, as described below. In such a case, the guide portion constitutes an additional safety measure to secure slippage of the spring leg from the first abutment surface until the second operating state is reached even if the spring leg has not slipped from the first abutment surface as desired due to a component defect such as an unintended deflection and/or bias.

Preferably, the guide portion has a guide surface and/or a guide channel on or in which a region of the spring leg is guided during the displacement of the closure member in the displacement direction, in particular substantially in a direction orthogonal to the displacement direction.

Preferably, the first abutment surface is oriented descending and/or obliquely to a plane orthogonal to the displacement direction. Thereby, in particular, friction between the first portion of the spring leg and the first abutment surface can be decreased, and the reliability of decoupling and/or slippage of the spring leg from the first abutment surface can be further increased, in particular to achieve decoupling with small tolerances. In particular, the guide portion and the first abutment surface advantageously cooperate in displacing and/or deforming the spring leg.

Preferably, in the first operating state, a region of the spring leg, in particular the second portion of the spring leg, abuts against a second abutment surface of the bearing member and/or is arranged adjacent to the second abutment surface. In this respect, the second abutment surface is preferably configured to limit and/or reduce and/or prevent displacement of the spring leg in the first operating state and/or over part of the displacement path of the closure member from the first operating state to the second operating state substantially orthogonally to the displacement direction. The second abutment surface preferably extends in the displacement direction only up to a region of the bearing device where the spring leg comes into contact with the guide portion so that the spring leg can be deformed and/or displaced substantially orthogonally to the displacement direction by the guide portion upon further displacement and/or deformation in the displacement direction without being hindered by the second abutment surface.

Preferably, the second abutment surface is oriented descending and/or obliquely to a plane orthogonal to the displacement direction, whereby, in particular, friction between the spring leg and the second abutment surface can be decreased and thus the reliability of decoupling can be further increased. The second abutment surface may be arranged obliquely such that as the closure member is displaced in the displacement direction, the spring leg deforms and/or can be displaced substantially orthogonally to the displacement direction. In particular, the guide portion, the first abutment surface and the second abutment surface advantageously cooperate in displacing and/or deforming the spring leg.

Preferably, in the second operating state, the clamping member is decoupled from the first abutment surface and the second abutment surface so that in the second operating state, no force acts from the clamping member, in particular the spring leg, on the closure member.

Preferably, the clamping member has a second spring leg. Thereby, the force impact on the closure member can be more reliably defined and/or distributed over different regions to achieve a more reliable function of the triggering.

Preferably, in this respect, the closure member has two substantially opposite and, preferably, oppositely oriented or extending first abutment surfaces via which the at least two spring legs of the clamping member can exert a force directed oppositely to the displacement direction for maintaining the first operating position.

Preferably, the bearing member has two substantially opposite and, preferably, oppositely oriented or extending second abutment surfaces, wherein each of the abutment surfaces prevents, or at least reduces or limits, radial displacement of one of the spring legs, respectively.

A symmetrical arrangement of the two spring legs and/or the two first abutment surfaces and/or the two second abutment surfaces is preferable. Thereby, in particular in the case of larger and/or elongated closure members, an uneven force impact and tilting and/or jamming can be prevented, or at least reduced, and thus a more reliable function of the protection device can be achieved.

Preferably, the closure member and the bearing member form at least one guide construction for guiding the relative displacement of these in the displacement direction. This has the advantage that jamming and/or tilting of the closure member can be prevented, or at least reduced, to increase a reliability of triggering of the protection device. In particular in the case of a large diameter and/or extension orthogonal to the displacement direction and a relatively small height and/or extension in the displacement direction of the bearing device, a guide construction supports appropriate displacement of the closure member relative to the bearing member so that reaching the second operating state is not prevented or not significantly hampered. Also, due to manufacturing tolerances, decoupling of the one spring leg cannot be effected simultaneously with the other spring leg so that there is an uneven force impact on the closure member from the clamping member. The guide construction may counteract a tilting caused thereby even when the closure member is configured to be flat, i.e. having a small axial length. In this manner, the protection device can be embodied flatter and/or more compact.

Preferably, the guide construction has a tongue-and-groove connection which is oriented substantially in the displacement direction. In this respect, the closure member may have a groove and/or a recess and/or a channel in which a tongue and/or a rib and/or a web of the bearing member is arranged displaceably, in particular translationally in the displacement direction. Alternatively, the bearing member has a groove and/or a recess and/or a channel in which a tongue and/or a rib and/or a web of the closure member is arranged displaceably, in particular translationally in the displacement direction. Preferably, the protection device has two or more guide constructions, preferably substantially uniformly distributed and/or symmetrically arranged, to achieve improved guidance.

Preferably, the protection device has a membrane having a predetermined permeability. Thereby, pressure compensation at a low relative pressure can take place without displacing the closure member. In this respect, the closure member may have the membrane, and/or the membrane is arranged on the bearing member and fluidically in parallel to the opening closed by the closure member.

The membrane preferably has a predetermined permeability to gases which is suitable to compensate for a pressure difference typically occurring in the automotive sector, in particular a pressure compensation of about +−0.1 bars due to temperature and/or height differences.

Alternatively, a membrane may be arranged additionally on the housing or only on the housing. In particular, a membrane may substantially close and/or cover a further opening of the housing.

Preferably, the membrane is substantially impermeable to dust, for example in accordance with protection level IP6X, to prevent foreign matter from entering the interior of the housing. Advantageously, at least one side of the membrane is substantially impermeable to water, for example in accordance with protection level IPX6K, IP6KX, IPX7, IPX9K or IPX8. A membrane having the protection level of IP 67 is particularly advantageous. Further preferably, the membrane is arranged on the closure member such that water is substantially prevented from entering the interior of the housing by the membrane. For example, the membrane consists of PTFE (polytetrafluoroethylene) having micropores or has a structure with corresponding properties. Alternatively and/or additionally, the membrane advantageously has air permeability of between about 1 and about 25 l/(dm2*min), more preferably between about 2.5 and about 10 l/(dm2*min) (in particular at a pressure drop of about 200 Pa-in accordance with DIN EN ISO 9237, for example). Preferably, the membrane has a thickness of between about 0.1 and about 0.5 mm, more preferably between about 0.13 and about 0.18 mm, in particular a thickness of about 0.14 mm.

Preferably, the clamping member has one or more spring legs. The spring leg may have no, one or a plurality of windings. The clamping member may in particular comprise bands and/or wires made of steel and/or spring steel and/or copper alloys such as, for example, beryllium copper, and/or nickel and/or titanium alloy and/or plastic and/or rubber. Preferably, the clamping member is formed of a spring steel alloy such as, for example, stainless spring steel. Alternatively and/or additionally, the clamping member may have one or more spring-loaded, elastic and/or deformable members which can suitably interact with the spring leg.

Preferably, the clamping member is in a biased state at least in the first operating state, with a bias towards the first abutment surface, so that a spring leg exerts a force opposite the displacement direction of the closure member at least in the first operating state on the closure member. By virtue of this bias in particular, the triggering pressure of the protection device may be set and/or defined.

Optionally, a spring leg may be biased in a direction substantially perpendicular to the displacement direction, in particular in a direction corresponding to the displacement and/or deformation of the clamping member caused by the guide portion. Thereby, displacement and/or deformation of the clamping member upon transition from the first operating state to the second operating state may be facilitated and/or supported. Preferably, at least a portion of the spring leg abuts against the second abutment surface of the bearing device by this bias.

Preferably, the closure member and/or the bearing member closes the opening of the housing. Preferably, the bearing member is designed and arranged around the opening and/or at the opening of the housing such that the bearing member radially encloses at least part of the closure member in the first operating state.

In particular, the bearing member may have a substantially cylindrical portion in which the closure member is arranged displaceably in the axial direction of the cylindrical portion in the first operating state.

The closure member is preferably arranged in a manner substantially exactly fitting in a passage opening of the bearing member and closes this passage opening in a substantially fluid-tight manner so that pressure compensation can take place only by means of the optional membrane of the protection device during normal operation.

Preferably, the closure member and/or the bearing member has one or more outlet openings or outlet recesses through which fluid, in particular gas, can escape from the interior of the housing when the closure member is in a third operating state, for example when the closure member has been displaced from the first operating state to a position where the opening has not been substantially completely released, that is, the closure member is not yet substantially completely released in the second operating state. In particular, the third operating state corresponds to a position of the closure member in the displacement direction between the first operating state and the second operating state. By virtue of the one or more outlet openings, limited release of the opening can advantageously be effected so that a relative pressure in the interior of the housing is not suddenly lowered but is first partially reduced and/or lowered by the outlet opening(s).

More preferably, the sum of the areas of the one or more exit openings is smaller than the completely released opening of the housing and/or the passage opening of the bearing member, being smaller preferably by 30%, more preferably by 50%, even more preferably by 80%.

Outlet openings may be rectangular, round, oval and/or conical and/or be provided substantially symmetrically on the closure member and/or on the bearing member.

The protection device may comprise a securing member for limiting displacement of the closure member beyond the position of the second operating state and/or for preventing decoupling between the closure member and the housing. A securing member may connect the closure member to the bearing member and/or the housing and may, for example, comprise a securing cable and/or band and/or belt and/or a bracket and/or a stopper member to suppress displacement of the closure member beyond a certain position so that the closure member is not separated and/or uncoupled from the housing and/or the bearing member. Advantageously, the securing member is formed integrally with the closure member and/or the bearing member. Alternatively, and/or additionally, the securing member may be formed in one or more pieces. Alternatively, or additionally, the securing member may be configured to reduce the kinetic energy of the closure member when reaching the second operating state to below a prescribed and/or prescribable value such as, for example, about 3 joules or less. For this purpose, the securing member may, at least in sections, have a structure which deforms when loaded while receiving energy such as, for example, a bellows, corrugated or spiral structure. The securing member may also have one or more predetermined breaking points for absorbing at least part of the kinetic energy of the closure member. The securing member may then be configured to allow complete decoupling of the closure member from the bearing member and/or the housing, but to reduce a kinetic energy of the decoupled closure member, in particular to below about 3 joules. When dimensioning and/or designing the securing member, the triggering pressure of the protection device and/or the spring force of the clamping member and/or the weight of the closure member is preferably taken into account. The securing member may be formed of a metal and/or plastic having a toughness as high as possible.

The protection device may comprise a seal arranged between the closure member and the bearing member and/or the housing, such as at an upper free edge region of the bearing member, so as not to hamper and/or hinder displacement of the closure member from the first operating state to the second operating state.

Further aspects of the invention relate to a housing, in particular a battery housing, comprising the protection device described above, and a battery system comprising such a housing having a battery storage located therein for storing electric energy. A further aspect of the invention relates to a vehicle, in particular a road vehicle, comprising such a battery system.

In the following, individual embodiments for achieving the object are exemplarily described based on the figures. In this respect, some of the individual embodiments described have features that are not necessarily required to implement the claimed subject matter, but that provide desired properties in certain applications. Thus, embodiments not having all the features of the embodiments described below should also be regarded as falling within the technical teaching described. Furthermore, to avoid unnecessary repetitions, certain features are only mentioned in relation to individual embodiments described below. It is noted that the individual embodiments should therefore be considered not only in isolation, but also in combination. Based on this combination, a person skilled in the art will appreciate that individual embodiments can be modified by incorporating one or several features of other embodiments. It is noted that a systematic combination of the individual embodiments with one or several features described in relation to other embodiments may be desirable and appropriate and therefore is to be taken into consideration and regarded to be also encompassed by the description.

### BRIEF DESCRIPTION OF THE DRAWINGS

FIG. 1 is a top perspective view of a protection device having a closure member in accordance with an embodiment of the invention.

FIG. 2 is a bottom perspective view of the protection device of FIG. 1 in a first operating state.

FIG. 3 is a cross-sectional view taken along line A-A in FIG. 2.

FIG. 4 is a cross-sectional view taken along line B-B in FIG. 2.

FIG. 5 is a cross-sectional view similar to FIG. 4 but showing a third operating state.

FIG. 6 is a cross-sectional view similar to FIGS. 4 and 5 but showing the protection device in a second operating state.

FIG. 7 is a bottom view of the protection device in the second operating state.

FIG. 8 is an exploded side cross-sectional view of a further design of a protection device in the second operating state.

### DETAILED DESCRIPTION

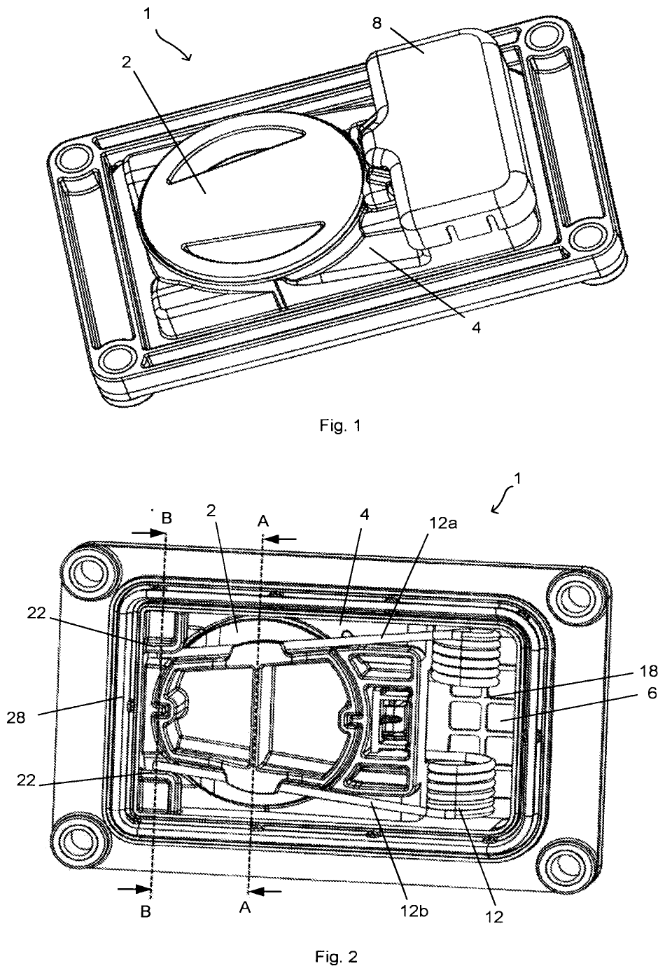

FIGS. 1 and 2 show an exemplary design of a protection device 1 having a closure member 2 in a first operating state. FIG. 1 shows the upper side of the protection device 1, i.e. the side of the protection device 1 that is directed outwardly when assembling to a housing. FIG. 2 shows the lower side of the protection device 1, i.e. the side of the protection device 1 that is connected to the housing.

The protection device 1 advantageously comprises a bearing member 4 that is configured to be connected and/or coupled to a casing of the housing 10, in particular a battery housing. In the illustrated embodiment, the bearing member 4 has a substantially cylindrical portion in which the closure member 2 is axially displaceable.

FIGS. 1 and 2 illustrate the closure member 2 of the protection device 1 in the first operating state where the closure member 2 is positioned to substantially seal and/or close and/or cover the opening 11 of the housing 10. In the first operating state, the protection device 1 is configured to close and/or seal the opening 11 of the housing 10 such that fluid, in particular gas, can escape from the interior of the housing 10 through the opening 11 and/or pass into the interior of the housing 10 substantially exclusively through an optionally arranged membrane 6. In the exemplary design shown, the protection device 1 has a membrane 6 that is arranged in the bearing member 4 next to the closure member 2. The membrane 6 is protected on the outer side by a cover cap 8 that is configured and/or arranged on the bearing member 4 such that gas can pass into the interior of the housing 10 or from the interior of the housing 10 to the outside through the membrane 6. Alternatively, or additionally, the closure member 2 may have a membrane 6 as shown in the design of FIG. 8, for example.

The closure member 2 depicted in FIGS. 1 and 2 is configured to be substantially bulb-shaped. In particular, the closure member 2 is configured to be arrangeable in a manner substantially exactly fitting in the bearing member 4 and displaceably therein. A substantially circular cross-section of the closure member 2 and a substantially cylindrical through-opening of the bearing member 4 in which the closure member 2 is arranged and through which gas can exit the housing through the closure member 2 when releasing the closure member 2, allows for advantageous sealing and guidance of relative displacement of the closure member 2 and the bearing member 4.

Alternatively, and/or additionally, the bearing member 4 may also be formed integrally with the housing 10. For example, the casing of the housing 10 may have structures that are suitable for storing and/or guiding the closure member 2.

The membrane 6 preferably is designed such that fluid, in particular gas, can flow and/or diffuse into the interior of the housing 10 through the membrane 6. However, the membrane 6 prevents, stops or blocks water and/or dirt and/or dust from entering the interior of the housing 10. Particularly preferably, the membrane 6 is configured in accordance with the specifications of protection level IP6X and/or IPX6-IPX8. For example, the membrane may comprise a PTFE film having micropores.

The membrane 6 may, in this respect, be arranged on the protection device 1 such that when the closure member 2 and/or the protection device 1 are in the first operating state, pressure compensation between the interior of the housing 10 and the atmosphere surrounding the housing 10 can take place. In other words: The membrane 6 preferably is arranged such that fluid can flow into the housing 10 and out of the housing 10 through the opening and the membrane 6 even when the closure member 2 closes the through-opening of the bearing member 4. The membrane 6 thus preferably forms a flow path for pressure compensation during normal operation. Advantageously, the area of the membrane 6 is as large as possible to obtain a pressure compensation capacity as high as possible. Preferably, a support structure 18, for example a grid, for supporting the membrane 6 is provided. Thus, the membrane 6 can be stabilized and/or a defect of the membrane 6 can be prevented.

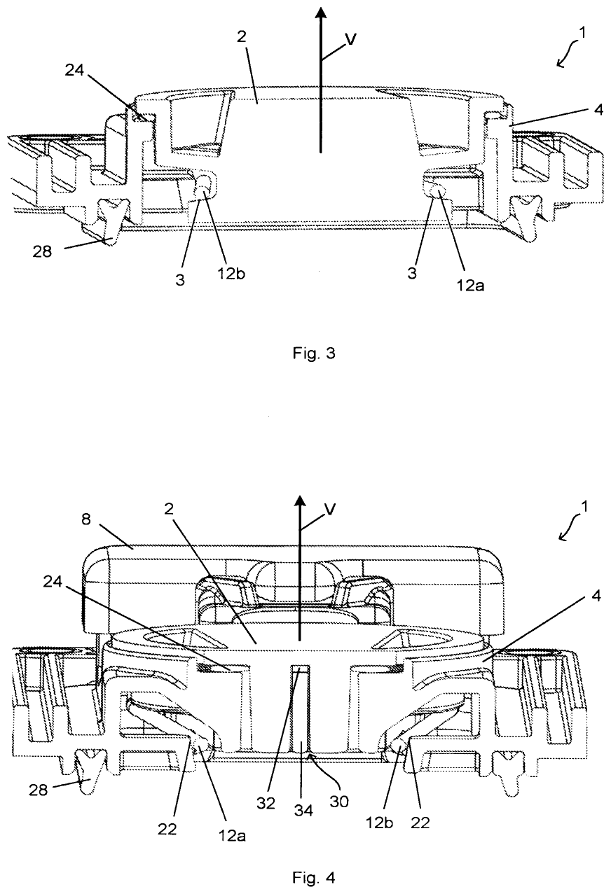

The protection device 1 comprises at least one clamping member 12 that is configured to at least temporarily fix and/or hold in position and/or lock the closure member 2 substantially in the first operating state. The clamping member 12 comprises at least one spring leg 12a/12b. In the exemplary design of the protection device 1, the clamping member 12 has a leg spring comprising a pair of spring legs 12a/12b. The clamping member 12 preferably has a spring steel alloy, preferably made of stainless spring steel, and/or a nickel and/or titanium alloy. The at least one spring leg 12a/12b is preferably supported with respect to the housing 10 and/or the bearing member 4 such that the spring leg 12a/12b is deformed elastically and/or biased in the first operating state and exerts a force towards the housing 10 on the closure member 2 to at least temporarily fix and/or hold in position the closure member 2 in the first operating state. In FIGS. 3 to 6, the interaction between the clamping member 12, the closure member 2 and the bearing member 4 in the different operating states is shown and described in detail elsewhere in this application.

As an alternative to the clamping member 12 shown, the protection device 1 may also comprise one or more differently designed clamping members 12, for example in the form of one or more springs and/or one or more spring-loaded and/or elastically deformable members that are coupled suitably to the at least one spring leg 12a/12b.

Preferably, a housing seal 28 achieves a substantially fluid-tight sealing between the protection device 1, in particular the bearing member 4, and the housing 10.

FIG. 3 is a sectional view taken along line A-A of FIG. 2 and shows the protection device of FIGS. 1 and 2 in the first operating state.

The closure member 2 is regionally radially surrounded by the bearing member 4 and closes the passage opening substantially tightly. In particular, a seat of the closure member 2 that is substantially fluid-tight and/or impermeable to fluid, in the bearing member 4 is preferable. To achieve such a tightness, one or more closure member seals 24 may be provided between the bearing member 4 and the closure member 2. The closure member 2 is displaceable to the second operating state in the displacement direction V substantially orthogonally to a surface of the housing 10.

In the first operating state, at least part of the clamping member 12, in particular a first portion of each of the spring legs 12a and 12b, is coupled to the closure member 2 and exerts a force on the closure member 2 to retain the closure member 2 in the first operating state. As depicted, the clamping member 12 preferably comprises two spring legs 12a and 12b that are biased substantially oppositely to the displacement direction V and towards the opening of the housing 10.

The spring legs 12a/12b of the clamping member 12 are coupled to the closure member 2, in particular to a first abutment surface 3 in the first operating state and hold the closure member 2 in position so that exit of fluids, in particular of gases, from the interior of the housing 10 through the opening 11 is prevented or at least significantly reduced. Preferably, a first portion of the spring leg 12a/12b is coupled to the first abutment surface 3.

As shown, the closure member 2 preferably has two substantially symmetrical first abutment surfaces 3 so that exertion of force on the closure member 2 by the clamping member 12 is effected in a substantially equally distributed manner.

Preferably, the first abutment surface 3 is oriented descending and/or obliquely to a plane orthogonal to the displacement direction. For example, the first abutment surface 3 may form an angle of up to about 40°, in particular of between about 10° and about 20°, in a manner descending radially outwards. Thus, friction between the first portion of the spring leg 12a/12b and the first abutment surface 3 can be decreased and decoupling and/or slippage of the spring leg 12a/12b from the abutment surface 3 radially outwards upon displacement of the closure member 2 in the displacement direction V can be supported.

As an alternative to the example shown, at least one of the first abutment surfaces 3 may be configured such that the spring leg 12a/12b can slip radially inwards. In this respect, the first abutment surface 3 may form a radially inwardly descending angle to support decoupling and/or slippage of the spring leg 12a/12b from the first abutment surface 3.

FIG. 4 is a sectional view taken along line B-B of FIG. 2 and shows the protection device of FIGS. 1, 2 and 3 in the first operating state.

As shown in FIG. 4, the bearing member 4 preferably comprises one or more second abutment surfaces 22 that may radially support the spring legs 12a/12b. Preferably, the second abutment surface 22 is configured such that a second portion, preferably arranged at a distal end region of one spring leg 12a/12b, comes into contact with the second abutment surface 22 and/or is arranged adjacent thereto. In this manner, radial displacement of the spring legs 12a/12b is substantially prevented, or at least limited and/or reduced, so that they do not lose the coupling to the first abutment surfaces 3 of the closure member 2 in the first operating state.

Preferably, the second abutment surfaces 22 are configured and arranged such that in the first operating state and over part of the displacement path of the closure member 2 in the displacement direction V to the second operating state, radial displacement of at least a portion of the spring legs 12a/12b is prevented and/or reduced and/or limited.

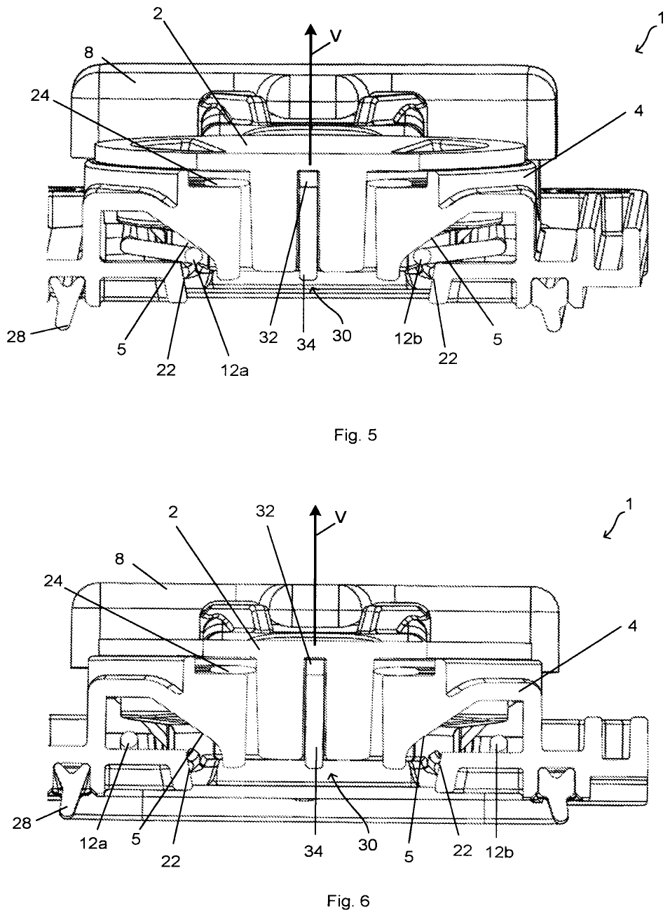

The spring legs 12a and 12b may be biased in a radial direction of the bearing member 4 and/or the closure member 2, i.e. in a direction substantially orthogonal to the displacement direction V. In particular, one or more spring legs 12a/12b may be configured, at least regionally, to be angled and/or bent radially outwards or inwards and/or in a manner diverging from one another or approaching one another. In this respect, the spring legs 12a and 12b may abut against the second abutment surfaces 22 in the first operating state. Thus, advantageous decoupling of the one or more spring legs 12a/12b from the closure member 2 upon displacement of the closure member 2 may be achieved, for example since in this manner, the one or more spring legs 12a/12b are substantially suddenly decoupled from the closure member 2 and/or slip therefrom at a certain position of the closure member 2 between the first operating state and the second operating state, as will be described in more detail with regard to FIGS. 5 and 6.

Regardless thereof, the second abutment surfaces 22 may form, at least regionally, an angle relative to a plane orthogonal to the displacement direction V and/or to the displacement direction V. In the example shown, the second abutment surfaces 22 are oblique to the displacement direction V and ascend radially outwardly. Thus, displacement of the spring legs 12a/12b and/or slippage of the spring legs 12a/12b from the second abutment surfaces 22 can be supported and/or accelerated.

In this and similar ways, the decoupling of the clamping member 12 from the second abutment surfaces 22 and from the closure member 2 and the resulting release of the opening 8 by the closure member 2 can be advantageously set and/or defined.

The protection device 1 may form a guide construction 30, where the closure member 2 and the bearing member 4 form a tongue-and-groove connection. In the example shown, the closure member 2 has a groove 32 aligned in the displacement direction V and/or a channel. The bearing member 4 has a correspondingly aligned and dimensioned tongue 34 and/or a protrusion that may be arranged displaceably in the groove 32. The guide construction 30 is particularly advantageous since in this manner, relative displacement between the closure member 2 and the bearing member 4 can be stabilized and/or guided to prevent, or at least to reduce, tilting and/or hindering and/or blocking of the relative displacement. This leads to a more reliable operation of the protection device 1.

Such a guide construction 30 is particularly advantageous if a diameter of the closure member 2 is large as compared to its height in the displacement direction. The greater the ratio between the diameter and the height, in particular height of the guidance by the bearing member 4, the earlier and/or stronger the closure member 2 will tilt and/or jam in the bearing member 4. Preferably, the protection device 1 has a closure member 2 having a diameter of between about 20 mm and about 50 mm, in particular between about 38 and about 42 mm, and a height of between about 8 mm and about 20 mm, in particular between about 10 mm and about 14 mm. For example, a preferable ratio between the diameter and the height of the closure member 2 is about 3:1 to about 4:1. Particularly preferably, an installation height of the protection device is lower than about 25 mm, in particular lower than about 18 mm.

FIG. 5 is the sectional view of FIG. 4 of the exemplary protection device 1 in a third operating state, where the closure member 2 has been displaced from the first operating state in the displacement direction V such that the spring legs 12a/12b are displaced and/or deformed as compared to the first operating state.

In the third operating state, the closure member 2 is in a position between the first operating state and the second operating state. In particular, the closure member 2 may be spaced apart from the closure member seal 24 of the bearing member 4.

To reach this state, the relative pressure in the interior of the housing 10 and thus the force acting on the closure member 2 from the interior of the housing 10 must be above a first limit value. The first limit value and the configuration of the protection device 1 are matched such that exit of fluid due to displacement of the closure member 2 does not occur until the first limit value is exceeded. In particular, the force which the clamping member 12 exerts on the closure member 2 is adapted such that the closure member 2 is displaced to the position of the third operating state when a certain positive pressure exists in the interior of the housing 10.

In the operating state shown, the spring legs 12a and 12b have been deformed and/or displaced by the first abutment surfaces 3 of the closure member 2 such that radial displacement and/or deformation of the spring legs 12a/12b and thus decoupling and/or slippage from the first abutment surfaces 3 are effected and thus it can be enabled to release the closure member 2 and/or to reach the second operating state.

For the displacement and/or deformation of the spring legs 12a/12b required for releasing the closure member 2, preferably one or more guides 5 are provided on the bearing member 4. A guide 5 preferably is configured such that a spring leg 12a/12b is actively decoupled and/or guided away from the first abutment surface 3 of the closure member 2. For this purpose, the guide 5 preferably comprises an oblique guide surface arranged such that a portion of the spring leg 12a/12b is displaced and/or deformed substantially orthogonally to the displacement direction and/or radially outwards by the guide surface upon displacement and/or deformation in the displacement direction V caused by the closure member 2. Thus, slippage and/or decoupling of the clamping member 12 from the closure member 2, in particular from the first abutment surfaces 3, is facilitated and/or supported, and the reliability of triggering of the protection device 1 can be increased. In particular, this compensates for a manufacturing tolerance and/or a defect of the clamping member 12.

As shown in FIG. 5, a distal portion of the spring leg 12a/12b abuts against the guide portion 5 so that upon further deformation and/or displacement of this portion of the spring leg 12a/12b in the displacement direction V, guidance and/or urging radially outwards is effected. As a result, a first portion of the spring leg 12a/12b, which is coupled to the first abutment surface 3 of the closure member 2, also is deformed and/or displaced radially outwards up to a position that the first portion is decoupled and/or slips from the first abutment surface 3 and substantially releases the closure member 2.

The guide portion 5 shown or a similar one offers the advantage that no bias of the spring legs 12a/12b orthogonal to the displacement direction and/or radially outwards is required and/or that tolerances and/or erroneous dimensioning of the bias radially outwards can be compensated for. Thus, the reliability of the protection device 1 can be increased.

In the case of an optional additional bias of the spring legs 12a/12b radially outwards, when reaching the position shown in FIG. 5, a substantially abrupt slippage of the spring legs 12a/12b from the second abutment surface 22 radially outwards is effected. Thus, a further preferable abrupt decoupling of the spring legs 12a/12b from the closure member 2 and/or release of the closure member 2 also is effected. However, the guide portion 5 allows for releasing the closure member 2 also without radial bias.

Optionally, the third operating state may be characterized such that the closure member 2 has been displaced up to a position where the protection device 1 no longer completely seals and/or substantially closes the opening 11 of the housing 10. In particular, in the third operating state, fluid can flow through the opening 11 from the interior of the housing 10 into the atmosphere and/or environment by virtue of one or more outlet openings 14 of the closure member 2. The one or more outlet openings 14 are preferably formed laterally in and/or on the closure member 2 to allow for substantially radial release of the fluid. Exemplary outlet openings 14 are shown in FIG. 8.

This third operating state is particularly advantageous to allow for a gradual and/or staged pressure reduction in the interior of the housing 10. Instead of a sudden and substantially complete release of the opening 8 of the housing 10 and an associated sudden pressure drop in the interior of the housing 10, a gradual and thus advantageous, material-friendly discharge and/or reduction of a positive pressure from the interior of the housing 10 through the opening 11 can be achieved by virtue of one or more outlet openings 14. In particular, the sum of the area of the released regions of the outlet openings 14 is smaller than the area of the opening 11.

The one or more outlet openings 14 in the closure member 2 may be designed, shaped and/or positioned so that an advantageous course of a drop in the positive pressure within the housing 10 can be achieved. In particular, an outlet opening 14 may be round, oval, rectangular and/or trapezoidal. Alternatively, and/or additionally, one or more outlet openings 14 may be arranged on the bearing member 4 to allow for gradual and/or staged outflow of fluid from the interior of the housing 10.

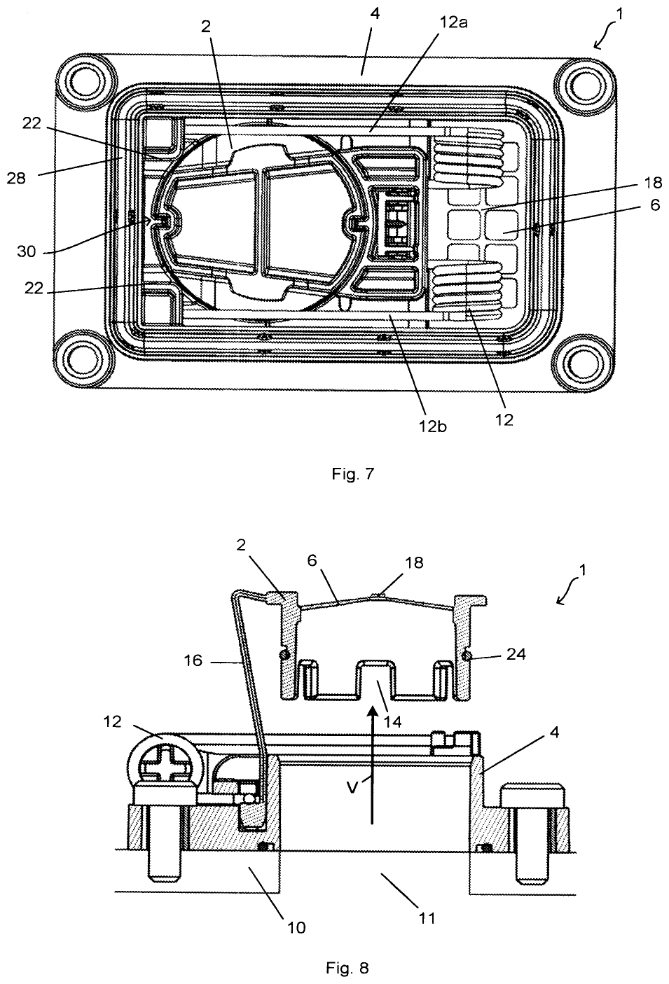

FIGS. 6 and 7 show the protection device 1 of FIGS. 1 to 5 in the second operating state where the closure member 2 is displaced with respect to the housing 10 and/or the bearing member 4 such that the closure member 2 is decoupled from the clamping member 12 and/or the opening 11 of the housing 10 is substantially completely released and/or the closure member 2 can be displaced farther in the displacement direction V substantially unhindered to substantially completely release the opening 11 of the housing.

In particular, the closure member 2 is positioned with respect to the bearing member 4 and/or the housing 10 such that the closure member 2 substantially no longer covers and/or closes and/or seals the opening 11 of the housing 10. In the preferable embodiment shown of the protection device 1 in the second operating state, the closure member 2 is displaced substantially in an axial direction of the cylinder formed by the bearing member 4 and away from the housing 10.

In this embodiment, the closure member 2 is in a position where it is still guided, borne and/or at least regionally radially surrounded by the bearing member 4.

The second operating state of the protection device 1 and/or the closure member 2 is in particular defined such that a flow path between the housing 10 and/or the bearing member 4 and the closure member 2 is formed which allows for a fluid flow of preferably more than about 1 l/s, more preferably more than about 30 l/s, even more preferably more than about 90 l/s, and/or preferably more than about 50 grams of gas per second, more preferably more than about 120 grams of gas per second. In the second operating state, the protection device 1 is preferably configured to reduce a positive pressure existing in the housing 10 with respect to the environment and/or atmosphere rapidly, preferably in less than one second, more preferably substantially immediately, through the opening 11.

As shown in FIG. 7, the spring legs 12a/12b of the clamping member 12 are not coupled to the closure member 2, i.e. no force is exerted on the closure member 2 by the clamping member 12.

In the second operating state, the clamping member 12 is preferably in a substantially non-tensioned and/or non-biased state. In particular, the spring legs 12a/12b of the clamping member 12 are not or only slightly tensioned towards the housing 10, in particular oppositely to the first operating state.

FIG. 8 shows a further design of an exemplary protection device 1 in a second operating state having a closure member 2 displaced in the displacement direction V. In this embodiment, the closure member 2 is located in a position where it is not guided and/or borne by the bearing member 4.

In this design, the membrane 6 is arranged on the closure member 2 to allow for pressure compensation between the interior of the housing 10 and the atmosphere surrounding the housing 10. Thus, the protection device 1 can be kept compact.

Preferably, a securing member 16 is provided to prevent complete decoupling and/or detachment of the closure member 2 from the protection device 1, in particular from the bearing member 4 and/or the housing 10. The securing member 16 is configured to retain the closure member 2 in the second operating state without the closure member 2 being completely decoupled from the bearing member 4 or the housing 10.

Alternatively, the securing member 16 may be configured and/or adapted such that decoupling of the closure member 2 from the bearing member 4 or the housing 10 is allowed, but a kinetic energy of the closure member 2 is reduced to below about 3 joules. Thereby, the decoupled closure member 2 cannot or can only cause minor damage to other components and/or objects and/or persons. In particular, a securing member 16 may have one or more predetermined breaking points which can decrease and/or at least partially absorb the kinetic energy of the closure member 2. Alternatively or additionally, the securing member 16 may have elastic and/or damping and/or absorbent materials and/or structures to reduce a kinetic energy of the closure member 2 when reaching the second operating state.

The closure member 2 has multiple outlet openings 14 described above through which fluid can flow from the interior of the housing 10 into the atmosphere and/or environment when the protection device 1 is in the third operating state. The one or more outlet openings 14 are preferably formed laterally in and/or on the closure member 2 to allow for substantially radial release of the fluid.

Preferably, the bearing member 4 is coupled and/or attached to the housing 10 with one or more fastening members 18. In the exemplary embodiment shown, screws are provided and are engaged with one thread in the housing 10, respectively.

The design of FIGS. 1 to 7 may have one or more of the features shown in FIG. 8. Also, the design of FIG. 8 may have one or more of the features shown in FIGS. 1 to 7.

### LIST OF REFERENCE NUMERALS

1 Protection device
2 Closure member
3 First abutment surface
4 Bearing member
5 Guide portion
6 Membrane
8 Cover cap
10 Housing
11 Opening
12 Clamping member
12a/12b Spring leg
14 Outlet opening
16 Securing member
18 Support structure
22 Second abutment surface
24 Closure member seal
28 Housing seal
30 Guide construction
32 Groove
34 Tongue
V Displacement direction

1. A protection device (1) for discharging a positive pressure from an interior of a housing (10), the protection device comprising:
a closure member (2) for sealing an opening (11) of the housing (10) in a first operating state, the closure member (2) being arranged displaceably with respect to the housing (10) and configured to be displaced to a second operating state in a displacement direction (V) without destruction;
a bearing member (4) for guiding the closure member (2),
at least one clamping member (12) having at least one spring leg (12a), wherein the at least one clamping member (12) is coupled to the closure member (2) in the first operating state to position the closure member (2) on the housing (10),
wherein the closure member (2) releases the opening (11) of the housing (10) in the second operating state,
wherein in the second operating state, the at least one clamping member (12) is decoupled from the closure member (2) so that the at least one clamping member (12) does not exert any force on the closure member (2) in the second operating state,
wherein in the first operating state, the at least one spring leg (12a) of the clamping member (12) abuts against a first abutment surface (3) of the closure member (2) and the first abutment surface (3) is configured, upon displacement of the closure member (2) in the displacement direction (V) to the second operating state, to displace and/or deform at least part of the spring leg (12a) such that the spring leg (12a) comes into contact with a guide portion (5) of the bearing member (4) and is displaced and/or deformed by the guide portion (5) such that the spring leg (12a) is decoupled from the closure member (2).

2. The protection device (1) of claim 1, wherein the guide portion (5) is configured to displace and/or deform the spring leg (12a) substantially in a direction orthogonal to the displacement direction (V).

3. The protection device (1) of claim 1, wherein the first abutment surface (3) is oriented descending and/or obliquely to a plane orthogonal to the displacement direction (V)

4. The protection device (1) of claim 1, wherein the spring leg (12a) abuts against a second abutment surface (22) of the bearing member (4) and the second abutment surface (22) is configured to substantially prevent displacement of the spring leg (12a) in the first operating state and over part of the displacement path of the closure member (2) to the second operating state substantially orthogonally to the displacement direction (V), and the second abutment surface (22) is oriented descending and/or obliquely to a plane orthogonal to the displacement direction (V).

5. The protection device (1) of claim 1, wherein in the second operating state, the clamping member (12) is decoupled from the first abutment surface and the second abutment surface.

6. The protection device (1) of claim 1, wherein the closure member (2) has two substantially opposite and oppositely oriented first abutment surfaces (3); the bearing member (4) has two substantially opposite and oppositely oriented second abutment surfaces (22); and the clamping member (12) has a second spring leg (12b).

7. The protection device (1) of claim 1, wherein the closure member (2) and the bearing member (4) form at least one guide construction (30) for guiding the relative displacement in the displacement direction (V).

8. The protection device (1) of claim 7, wherein the guide construction (30) has a tongue-and-groove connection that is oriented substantially in the displacement direction (V).

9. The protection device (1) of claim 1, wherein the protection device (1) has a membrane (6) with a predetermined permeability.

10. The protection device (1) of claim 1, further comprising a securing member (16) for limiting displacement of the closure member (2) beyond the position of the second operating state and for preventing decoupling between the closure member (2) and the housing (10).

11. The protection device (1) of claim 1, further comprising a securing member (16) for reducing a kinetic energy of the closure member (2) when reaching the second operating state to below a prescribed or prescribable value, the securing member (16) having one or more predetermined breaking points for absorbing at least part of the kinetic energy of the closure member (2).

12. The protection device (1) of claim 1, wherein the clamping member (12) comprises at least one leg spring.

13. The protection device (1) of claim 1, wherein the closure member (2) has one or more outlet openings (14) through which fluid can escape from the interior of the housing (10) when the closure member (2) is in a third operating state.

14. A housing (10) comprising the protection device (1) of claim 1.

15. A battery system comprising the housing (10) of claim 14 and at least one battery storage for storing electric energy.

16. A vehicle comprising the battery system of claim 15.
